(19) United States
(12) Patent Application Publication
(10) Pub. No.: US 2026/0352492 A1
(43) Pub. Date: Nov. 5, 2026

(54) AUTOMATIC AUTHENTICATION OF A CIVILIAN EMERGENCY VEHICLE

(71) Applicant: AUDI AG, Ingolstadt (DE)

(72) Inventor: Thorsten HEHN, Ingolstadt (DE)

(73) Assignee: AUDI AG, Ingolstadt (DE)

(21) Appl. No.: 19/119,919

(22) PCT Filed: Sep. 28, 2023
(86) PCT No.: PCT/EP2023/076946

§ 371 Date: Apr. 10, 2025

(30) Foreign Application Priority Data
Oct. 10, 2022 (DE) 10 2022 126 216.2

(51) Int. Cl. H04L 9/32; H04W 4/46

(52) U.S. Cl. CPC H04L 9/3263; H04L 9/3247; H04W 4/46; H04L 2209/84

(57) ABSTRACT

Method for authenticating a vehicle, in particular an operational vehicle, as well as control device for a vehicle, and vehicle.

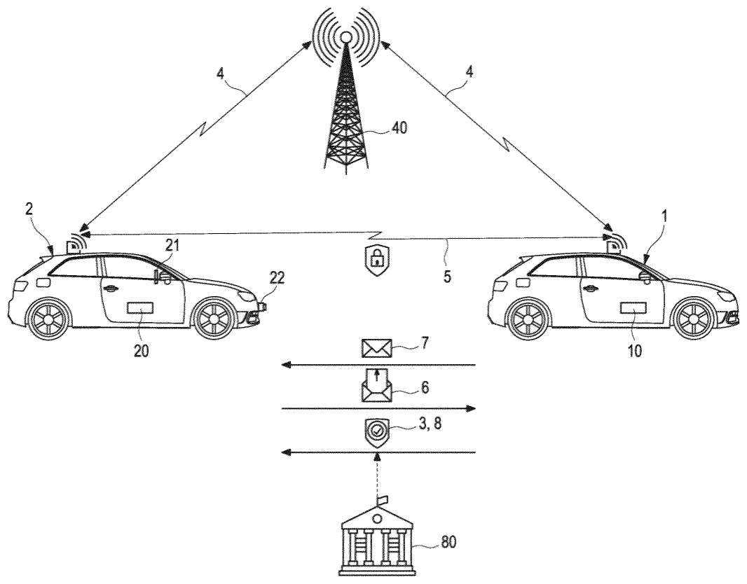

### CROSS-REFERENCE TO RELATED APPLICATIONS

This application is a U.S. national stage of International Application No. PCT/EP 2023/076946, filed on Sep. 28, 2023, which claims the priority benefit of German Patent Application No. 10 2022 126 216.2 filed on Oct. 10, 2022. Both the International Application and the German Patent Application are incorporated by reference herein in their entirety.

### BACKGROUND

### 1. Field

Examples of an invention relate to a method for authenticating a vehicle. The examples of the invention further relate to a control device for a vehicle, and to a vehicle.

### 2. Description of the Related Art

US 2022/309918 A1 discloses a method for identifying a vehicle, in particular an operational vehicle or an accident vehicle, in which a control device of a vehicle receives from a further vehicle, over a wireless connection from the further vehicle, an identifier of the further vehicle.

The standard ETSI EN 302 637-2 V1.4.1 discloses a method in which an operational vehicle on duty sends, over V2X, a Cooperative Awareness Message, CAM, signed with a valid digital certificate. Formats of digital certificates for signing a CAM are specified in ETSI TS 103 097V 1.3.1.

For data traffic on the World Wide Web, WWW, on the other hand, digital Secure Socket Layer (SSL) certificates are used, which can be displayed in any Internet browser, as taught in an article “How to View SSL Certificate Details in Each Browser” written by Julie Olenski and published on Jun. 2, 2017 on globalsign.com.

Police officers regularly carry out traffic checks to ensure safe road traffic. During a traffic check, a police officer usually checks data relating to a vehicle and a driver of the vehicle. The data relating to the vehicle may be determined, for example, on the basis of a vehicle identification number (VIN) and/or a TÜV certificate. The data relating to the driver may be determined by means of a so-called owner query based on an official license plate number of the vehicle and/or on the basis of an identification document of the driver, for example an identity card or driving license. The police officer usually stops the vehicle during a traffic check and speaks to the driver of the vehicle in order to determine the necessary data. However, the conversation situation at the driver's door of the vehicle is complicated, and is risky for the police officer. This is because, for example, the driver may use armed force to evade the check.

In order to reduce the risk of a traffic check for the police officer, US 2018/0047122 A1 and US 2022/0014907 A1 each disclose a method for verifying a vehicle and a driver of the vehicle, in which a vehicle stores data relating to the vehicle and a driver of the vehicle, receives a verification request from a checking device over a wireless connection, and transmits the stored data to the checking device as a response to the verification request. The checking device may be installed in a police vehicle or be realized as a mobile device and actuated automatically or manually by the police officer during the traffic check.

Police officers often use civilian operational vehicles to carry out traffic checks.

Compared to the conspicuously painted operational vehicles, the civilian operational vehicles offer the advantage of anonymity, which makes traffic checks more efficient. A traffic check by a civilian vehicle is risky for the driver of the vehicle being checked. This is because an occupant of the civilian vehicle may pretend to be a police officer and actually assault the checked vehicle after it has been stopped.

In order to reduce the risk of an unauthorized traffic check, EP 0 950 230 B1 discloses a method for authenticating a police officer, in which a police officer wirelessly transmits a license plate of a stopped vehicle to a stationary database server by means of a first mobile terminal, and the stationary database server provides a wireless connection to a second mobile terminal associated with the transmitted license plate and arranged in the stopped vehicle, and transmits an authentication of the police officer to the second mobile terminal over the wireless connection provided.

However, the latter method requires a complex stationary infrastructure and is difficult to handle, in particular for a driver of the stopped vehicle.

### SUMMARY

An example object of the invention may be to provide a method for authenticating a vehicle that facilitates a traffic check and increases the safety of the traffic check. Further example objects of the invention are to provide a control device for a vehicle, and a vehicle.

One subject-matter of examples of the invention is a method for authenticating a vehicle. The vehicle is, for example, a civilian operational vehicle that carries out a traffic check and, in the process, inspects a private vehicle. The civilian operational vehicle authenticates itself to the private vehicle being checked.

According to an example of the invention, a first control device of a first vehicle transfers a digital certificate to a second control device of a second vehicle by a V2X (Vehicle-to-Everything) message, the second control device receives the transmitted digital certificate, and a display device of the second vehicle displays the received digital certificate as an authentication of the first vehicle. In this way, a driver of the second vehicle can easily see by looking at the display device whether the first vehicle is authentic. Authenticity of the first vehicle is particularly important for the driver of the second vehicle if the first vehicle appears to be a civilian operational vehicle and stops the second vehicle as part of a traffic check. The digital certificate increases the safety of the driver of the second vehicle during the traffic check.

In an example, the second control device transmits an authentication request to the first control device by a V2X message, and the first control device transmits the digital certificate as a response to the authentication request. By the authentication request, the second control device prompts the first control device to transmit the digital certificate. The driver of the second vehicle may trigger the transmission of the authentication request manually, for example if the first vehicle is travelling ahead of the second vehicle and, by a visual and/or auditory indication that can be perceived by the driver of the second vehicle, requests the second vehicle to follow.

Advantageously, the second control device, by a sensor or by receiving a V2X message, recognizes the first vehicle as an official operational vehicle and, following the recognition, the second control device transmits the authentication request. If the second vehicle recognizes the first vehicle as a civilian operational vehicle, the second vehicle automatically triggers the transmission of the authentication request, thereby further simplifying the authentication of the first vehicle. The recognition by sensor may include visually capturing an image of the first vehicle by a camera of the second vehicle. For example, the second vehicle may recognize a visible “Please follow” text displayed in the captured image by the first vehicle.

The second control device may receive a Basic Safety Message, BSM, from the first control device, recognize a V2X capability of the first vehicle and, following the recognition, transmit the authentication request. On the one hand, receiving the BSM confirms the V2X capability of the first vehicle. On the other hand, the second control device may use the BSM to determine a relative position of the first vehicle with respect to the second vehicle and ascertain the plausibility of the determined relative position, thereby further increasing the safety of the traffic check.

Ideally, the second control device displays the received digital certificate if the transmitted authentication request is correctly signed and the signature indicates an entity authorizing the first vehicle. The first control device signs the received authentication request with the digital certificate. The second control device checks the correctness of the received digital certificate. The second control device additionally checks whether the signature has been issued and/or verified by a trustworthy authority, i.e. the entity authorizing the vehicle. In this way, the safety of the traffic check is further increased.

The digital certificate may be transmitted while the second vehicle is travelling. This means that the authenticity of the first vehicle is already established before the second vehicle is followed and/or stopped, thereby further increasing the safety of the traffic check. For example, the second vehicle does not need to follow the first vehicle into an obscure location if the first vehicle is not actually a civilian operational vehicle.

In one example, the digital certificate is transmitted over a V 2X connection or a 5G-V2X connection. The V2X connection between the first and the second vehicle is provided directly by respective communication units and does not require a stationary infrastructure. If the first vehicle and/or the second vehicle cannot provide a direct V2X connection, but can provide a mobile telephony connection, V 2X messages are alternatively transmitted over a 5G mobile telephony network.

Expediently, the digital certificate is transmitted over a secure connection. The secure connection may be encrypted. Other, uninvolved vehicles are precluded from recognizing the authentication of the first vehicle. This ensures the anonymity of the first vehicle, for example a civilian operational vehicle.

The driver of the second vehicle is informed by the display device whether the first vehicle has a V2X capability and -if so-whether or not the first vehicle is authentic, for example whether or not it is a civilian operational vehicle.

Another subject-matter of an example of the invention is a control device for a vehicle.

The control device may be functionally connected to a bus system of the vehicle. The control device may be realized as a module implemented by computer hardware and/or software executed by the computer hardware that may include a computer processor, in particular a software module, and integrated in a further control device of the vehicle.

According to an example of the invention, the control device may be configured to act, as the first control device or as the second control device, in combination with a method according to an example of the invention. The control device enables a simpler and secure authentication of the first vehicle with respect to the second vehicle.

A further subject-matter of an example of the invention is a vehicle. The vehicle may be realized as a civilian operational vehicle or as a private vehicle.

According to an example of the invention, the vehicle comprises a control device according to an example of the invention. If both the operational vehicle and the private vehicle comprise the respective control device, the first vehicle can automatically authenticate itself as a civilian operational vehicle with respect to the second vehicle. In this way, a traffic check is simplified, and its safety increased, by the two vehicles.

A significant advantage of the method according to the examples of the invention may be that a traffic check is facilitated, and the safety of traffic control is increased.

### BRIEF DESCRIPTION OF DRAWINGS

The invention is represented schematically in the drawings on the basis of an example, and is described further with reference to the drawing. In the drawing:

A FIGURE shows a functional diagram of two vehicles, each according to an examples of the invention.

### DESCRIPTION

The FIGURE shows a functional diagram of two vehicles 1, 2, each according to an example of the invention. The vehicle 1 comprises a control device 10 according to an example of the invention. The vehicle 2 comprises a control device 20 according to an example of the invention, and a display 21. The second vehicle may also have a sensor 22. The control devices 10, 20 are configured to act, as a first control device 10 and as a second control device 20, respectively, in combination with a method, described below, according to an example of the invention for authenticating the vehicle 1.

The second control device 20 may receive a Basic Safety Message, BSM, 7 from the first control device 10 and, on the basis of the received BSM 7, recognize a V2X capability of the first vehicle 1. Alternatively or additionally, the second control device 20 may recognize the first vehicle 1 as an official operational vehicle by a sensor 22, for example a camera, or by receiving a V2X message. Following the recognition, the second control device 20 may transmit an authentication request 6 to the first control device 10 of the first vehicle 1.

In particular, the second control device 20 may transmit the authentication request 6 to the first control device 10 by a V2X message.

The first control device 10 of the first vehicle 1 transmits a digital certificate 3 to the second control device 20 of the second vehicle 2 by a V2X message. In particular, the first control device 10 may transmit the digital certificate 3 as a response to the authentication request 6.

The digital certificate 3 may be transmitted while the second vehicle 2 is travelling, for example over a V2X connection 5 or a 5G-V2X connection 4. The 5G-V2X connection 4 is provided by a base station 40. In an example, the digital certificate 3 is transmitted over a secure connection 4, 5.

The second control device 20 receives the transmitted digital certificate 3, and a display device 21 of the second vehicle 2 displays the received digital certificate 3 as an authentication of the first vehicle 1. Advantageously, the second control device 20 displays the received digital certificate 3 if the transmitted authentication request 6 is correctly signed and the signature 8 indicates an entity 80 authorizing the first vehicle 1.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 3d 870, 69 USPQ 2d 1865 (Fed. Cir. 2004).

### LIST OF REFERENCE DESIGNATIONS

1 first vehicle
10 first control device
2 second vehicle
20 second control device
21 display device
22 sensor
3 digital certificate
4 5G-V2X connection
40 base station
5 V2X connection
6 authentication request
7 BSM
8 signature
80 authorizing entity

1-10. (canceled)

11. A method of authenticating a vehicle among a plurality of vehicles, comprising:
transmitting, by a first control device of a first vehicle among the plurality of vehicles, a V2X message transferring a digital certificate to a second control device of a second vehicle among the plurality of vehicles;
receiving by the second control device the digital certificate transmitted by the first control device of the first vehicle, and displaying by a display device of the second vehicle, the received digital certificate in form an authentication of the first vehicle.

12. The method as claimed in claim 11, further comprising:
transmitting, by the second control device, an authentication request by a V2X message to the first control device, and transmitting, by the first control device, the digital certificate as a response to the authentication request.

13. The method as claimed in claim 12, further comprising:
recognizing, by the second control device, based upon a sensor or a V2X message, the first vehicle as an official operational vehicle and, following the recognizing, transmitting the authentication request.

14. The method as claimed in claim 13, further comprising:
recognizing, by the second control device a V2X capability of the first vehicle based on a Basic Safety Message (BSM) from the first control device, and, following the recognizing, transmitting the authentication request.

15. The method as claimed in claim 12, in which the second control device displays the received digital certificate if the transmitted authentication request is correctly signed and a signature indicates an entity authorizing the first vehicle.

16. The method as claimed in claim 11, in which the digital certificate is transmitted while the second vehicle is travelling.

17. The method as claimed in claim 11, in which the digital certificate is transmitted over a V2X connection or a 5G-V2X connection.

18. The method as claimed in claim 11, in which the digital certificate is transmitted over a secure connection.

19. A control device for a vehicle, the control device being configured to execute, as the first control device or the second control device, the method as claimed in claim 11.

20. A vehicle, comprising the control device as claimed in claim 19.
